(19) United States
(12) Patent Application Publication
(10) Pub. No.: US 2005/0240955 A1
(43) Pub. Date: Oct. 27, 2005

(54) Tv programme material assemblage

(76) Inventor: Jonathan Olaf Hudson, Bedford (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/520,110

(22) PCT Filed: Jul. 4, 2003
(86) PCT No.: PCT/GB03/02913

§ 371 Date: Jan. 3, 2005

(30) Foreign Application Priority Data
Jul. 4, 2002 (GB) 0215378.1

(51) Int. Cl. H04H 9/00

(52) U.S. Cl. 725/9; 725/23

(57) ABSTRACT

The present invention provides a method of assembling programme material involving the steps of (a) distributing clues defining or alluding to content to be broadcast as a television segment or assembled for that potential purpose; (b) receiving a plurality of content presentations, received content being based on an interpretation of said clues; and (c) forming said received content into an assemblage of material for broadcast. In addition, the method may include the step of selecting at least one said presentations for broadcast.

The present invention relates to Programme Material Assemblage and in particular to means and methods for providing an assemblage of programme material to support a predetermined television format, that is the structure of a programme to be broadcast.

Many formats are essentially competitions or quizzes in the sense that there are questions or clues intended to solicit answers or the performance of tasks from contestants. Typically contestants are studio based or selected beforehand, the opportunity for participation being in the hands of the programme makers rather than at liberty of potential contestants. There is no advance knowledge of the possible tasks and it is not possible to enter as a contestant on the spur of the moment or if aptitude or impulse to participate is felt for a particular task.

Hence, the possibilities for participation by the greater audience are very limited. Even though present communications technology can provide connectivity, participation is limited to simple voting and phone-ins. Interactive technology may provide easier connectivity but scope for participation remains limited to menu selections and polling, often following the activities of the pre-selected contestants themselves.

It is an object of the present invention to rebalance potential participation in favour of the general audience itself.

According to the present invention there is provided a method of assembling programme material involving the steps of
a) distributing clues defining or alluding to content to be broadcast as a television segment or assembled for that potential purpose;
b) receiving a plurality of content presentations, received content being based on an interpretation of said clues; and
c) forming said received content into an assemblage of material for broadcast.

In addition, the method may include the step of selecting at least one of said presentations for broadcast.

The present invention further provides a method of doing business based on the assemblage of programme material to support the novel formats described herein and the trade transactions between programme maker and participants in so doing. Although it is possible to generate revenue from for example call charges for answers supplied to questions, this does not itself create programme material beyond the mere padding provided by the segment in which the quiz is presented. Pictorial or Video items on which the questions themselves may be based or scenes depicting actual or potential answers are still required from the programme maker himself.

According to a further aspect of the present invention there is provided a method of doing business including the steps of generating revenue from contestant submission of programme material to be broadcast.

The present invention yet further provides a method of assembling material from which programme data to be broadcast may be selected or derived.

In programming based for example on audience submitted video tapes, the data must be edited and presented for broadcast according to the television transmission standard in use. Video data itself is not processed beyond normal editing and video standard translation. By contrast, the present invention provides means and methods by which submitted material can itself become part of the assemblage of programme material.

It is a further object of the present invention to provide a method of configuring data as part of programme content creation itself.

According to a yet further aspect of the present invention there is provided a method of assembling video data to be broadcast including the steps of audience or participant collection of said data at a remote site, transmitting said data in a compressed format in accordance with a first standard to a programme creation suite, using said data to create a programme segment, and broadcasting said data in accordance with a second standard.

Preferably said step of data collection is performed with a handheld communication device, such as a photo or video capture capable, mobile telephone.

Further aspects of the present invention are defined in the claims appended hereto.

In order that features and advantages of the present invention may be further appreciated, some embodiments will now be described by way of example only.

An exemplary format in accordance with the present invention may be used to create TV entertainment programmes with a working title of ‘Video Victors’.

This exemplary format takes a modular approach to a game show and provides for integration of enabling technologies. It is offered as for example a M hour format with flexible modules, or offered as shorter strand formats as inserts for other entertainment formats. In developing this format, the inventor has attempted to ensure that:
a compelling reason is provided for the viewer to participate using new but every day technology. A purpose of the format is to:
exploit what can be done well in both live and pre-recorded production environments, in particular to:
recognise the speed with which new technology will transform the nature of strand ‘content’ and the ways in which it will be collected and assembled and in particular to provide an assemblage of such content to support the format.

Whilst each challenge is devised with the entertainment aspect at the forefront, it is the combination of content, its mode of collection and assembly and its assemblage into material to be broadcast which is a key inventive concept.

With photo-capable mobile phones and digital recording/editing now becoming more and more within reach of the average consumer, the possibilities for creativity and revenue generation are very realistic. This technical combination can provide value to a broadcaster

There has been a lot of talk of ‘convergence’ and exciting new technology-based entertainment formats. The problem with so many attempts is that they assume that the public pointing cameras at what they like will provide entertaining content. Sadly this is not the case.

The present modular format has been developed specifically to allow technology-based audience participation to add a new and growing dimension to what is an innovative entertaining TV concept in its own right. The focus is on having a way to attract entertaining pictures or video clips—this is achieved by creating a structure whereby people ‘aspire’ to achieve something defined and controlled by the show itself.

More details of exemplary strands which lead to an assemblage of format supportive material are presented in Appendix I.

SMS Text messages are already exploited for entertainment formats as a way of involving the audience and creating a lucrative revenue stream to the mobile phone operators, TV production companies, format distributors and broadcasters. Mobile phones are increasingly capable of making it easy to take and transmit photos and video clips on the spur of the moment.

The invention provides for TV shows to solicit these pictures as TV content in the same way they do today for SMS Text messages. Mobile phone technology does enable video clips of (say) I minute duration to be captured and sent by the public in just the same way. It will be extremely beneficial to a broadcaster to have licenses to game show formats which attract mobile ‘return channel’ content not only to attract large audiences but also to enjoy financially attractive arrangements with the mobile phone service providers.

The Video Victors modular format for example offers the possibility to establish the audience today employing mobile phones which have a picture capture facility as well as using current Still/Video Camera and internet technology, thereby creating a demand for still picture and video clips over mobile devices.

As will be appreciated fundamental to the Video Victors format is:

It uses challenges where the right answer links to pictures/video (what TV does best):—ie contrived picture or video situation which contestants have to aspire to by guessing the right answer (filmed studio contestants and/or . . . viewer interactivity via sms caption, photo or video clip)

It ensures ongoing ‘freshness’ due to its topicality—challenges are all hooked into mass culture topics of discussion (pub-talk/tabloid newspaper topics)

It exploits a migration path towards live participation from sms text captions to photo to video clips as the installed technology allows real-time response. In particular video data may be captured on a video capable mobile telephone device. Presentations may be created on the spot and submitted for potential broadcast. If the programme is live the transmitted presentation may be broadcast as part of a current programme.

It enables the viewer challenges to get tougher over time with increasingly tough time goals.

It's a format which works both as pre-recorded or live versions, with minimal or maximum home viewer involvement.

An attractive aspect of the format is that a wide range of interpretations will come in allowing researchers to weave any number of contrived themes for the next show . . . ‘and this week we had yet another inflatable whale, etc . . . much of the fun comes from having the contestants in the studio being teased and humiliated about how wrong they've been!

A second exemplary format is present at Appendix II.

This format provides a clue to the participant in the form of some transmitted content to be identified.

In this case the assemblage of content from participants includes their related story and/or video content.

In this case, an artefact is required (e.g. actual disc bearing content) and the content is externally verified thus occasioning a further business transactions.

Upon verification a code number may be transmitted which has been issued by the verifier. In this way a simple SMS text message can effectively add to the assemblage of content since the verification is considered equivalent to submitting the actual content.

This provides a way for older technology still to enable participation.

In other games, for example treasure hunts, an artefact discovered could likewise be externally verified. Transmission of a verification code associated with that artefact could them amount to transmission of a picture of the artefact itself.

A further benefit of this invention is the collection of personal information across a large number of people in a very short space of time. Data concerning specific types of consumer equipment (mobile phone, camera, video and PC) being used can be collected and counted and used for target marketing purposes. Likewise significant statistical data can be created concerning the pervasion, existence and ready accessibility of any type of artefact (e.g. domestic objects, types of music recordings . . . in fact any artefact that can be requested as part of one of the games demanding an action)

Such data can be collected and compared over very specific time periods which hitherto have not been possible in large quantities.

### APPENDIX I

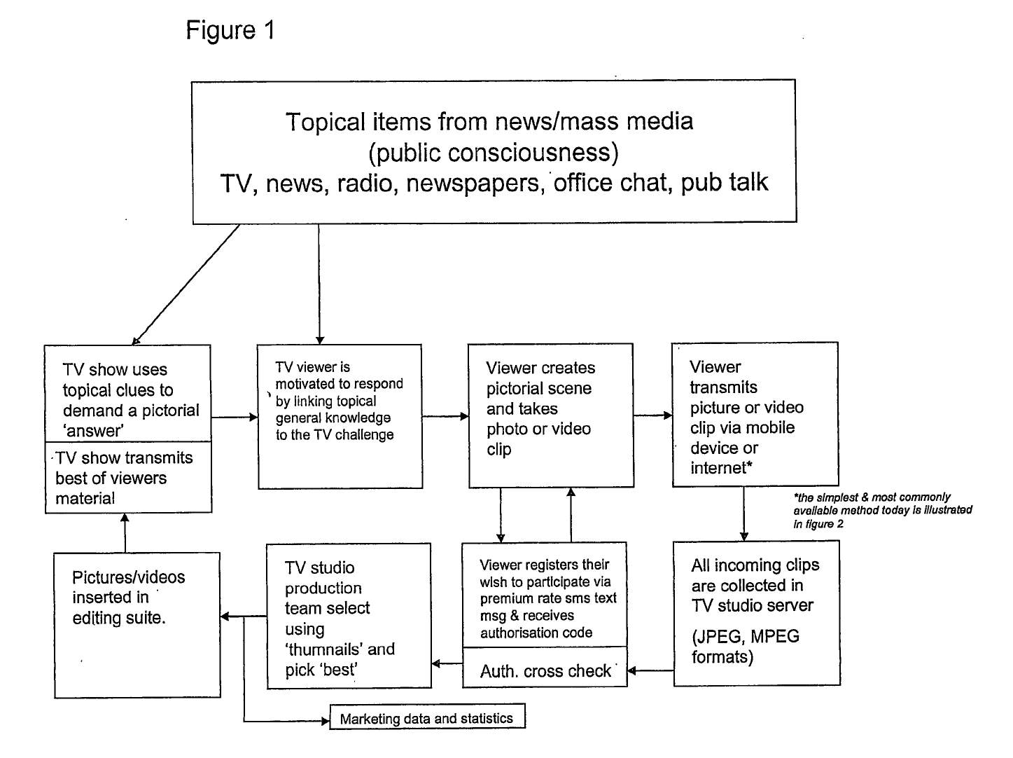

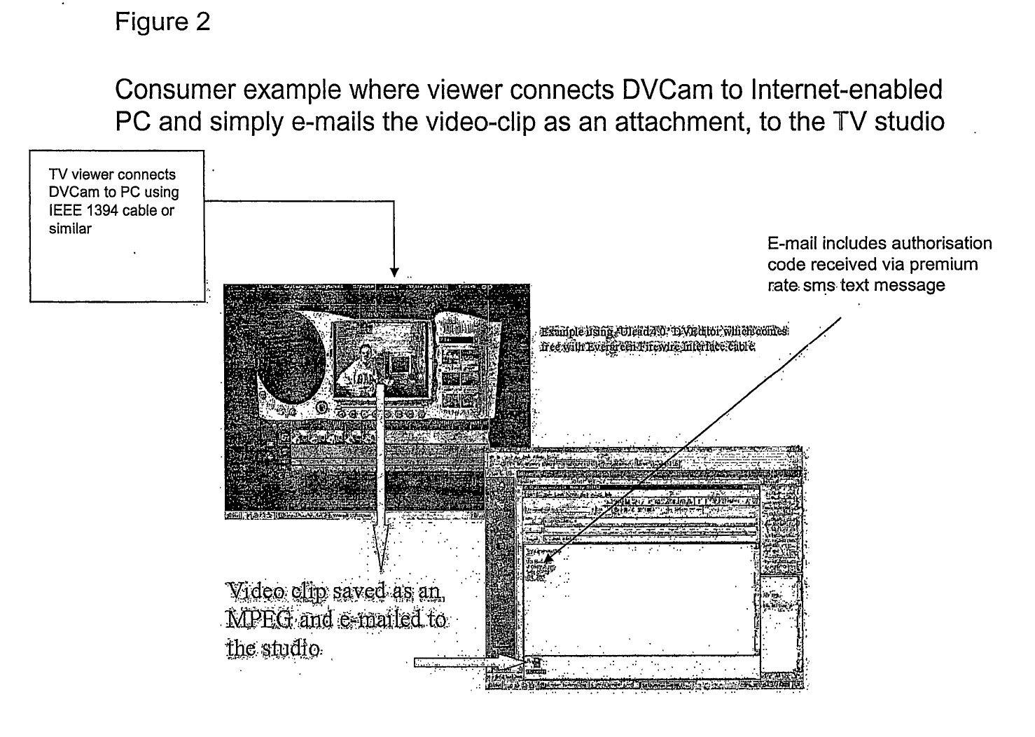

### FIG. 1 Shows the Flow in Pictorial Form

### VIDEO VICTORS

### SECTION A—STRAND FORMATS

PHOTO-BASED CHALLENGES

For use with photo-capable mobile phones or digital cameras.

As with all Video Victors games, the broadcast entertainment programme invites the viewing audience to respond in a given way. Various games can be played within this context with photo-based technology, as follows:

Game 1—Scavenger Hunt

The viewing audience has to send back a photograph of an unusual or hard-to-find object—e.g. a Faberge egg, last Tuesday's Daily Express, a four-leafed clover.

Game 2—Video Quiz

As per game 1, but a general knowledge question is asked. The viewing audience has to send back a photograph of their answer. The answer could be something straightforward—e.g. “Which fruit has its seeds on the outside?”, in which case the correct response would be a picture of a strawberry. It could also be more challenging—for example, if the question was “What pageantry ceremony does the Queen attend on her official birthday?”, the audience would somehow have to take a picture of Trooping of the Colour, probably by re-enacting it at home!

Game 3—What Happened Next?

We show the first few frames of a photo-based cartoon strip (as seen in many comics and magazines). The audience is invited to photograph and send in the next frame of the story. Part of the skill will be to make their photo fit visually as well as possible. For the best pictures, studio researchers would use text messages or voice calls to contact the selected viewers and allow them to add captions or voiceovers on top of their picture. The members of a studio audience votes for which picture is the best.

Game 4—Wanted

We show the photograph of a wanted person, who is roaming the streets of a mystery town. Various clues are given about the person and their whereabouts throughout the programme.

To claim the “reward”, any member of the public has to take their photo and send it back to the studio.

Game 5—Outdoor Challenge

Two contestants are given photographic phones. They are challenged to provide as much photograph proof as possible of a certain criterion—e.g. “Photograph as many people as possible who are wearing red underwear.” The person who performs best wins a prize.

Game 6—Treasure Trove

A web cam films a certain location throughout the programme. As the show progresses, the web cam's field of view gradually zooms out, thus showing more of the location. The winning contestant has to either take a photograph of the location or appear on the web cam themselves.

Game 7—Hold the Front Page

The host teases the viewers with humorous references to topical news items. Hidden from view is a funny picture which cleverly links two or more of the topical stories—for example, it might be a newspaper cartoon or a photomontage. Members of the public have to use guesswork and creativity to recreate or ‘better’ our photo and send us a photograph their results in just a matter of half an hour. The studio audience votes for which picture is the closest or funniest.

Game 7a—Hold the Front Page—Texting Version

As a complement to Game 7, instead of asking for photos to be sent, additional amusing ‘front page’ pictures can be presented as a caption competition where the public simply sends a text message to the show with their guess at the ‘right caption’. This will allow active participation by an even wider audience.

Game 8—Mystery Objects

An unusual object is hidden from view. The host asks viewers to guess the object and send in camera shots of them holding a similar object.

VIDEO-BASED CHALLENGES

For use with videophones, videocamera/PC setups or digital cameras and cameraphones that can take 30/60 second video clips.

Game 1—Video Victors (as a Main Game)

This involves two sets of studio contestants. They are provided with a number of clue objects that relate to a topical event that will happen in the next few days.

Each team of 2-3 contestants is challenged to film (possibly with professional outside broadcast production help provided by the programme maker) a certain activity during this time. The exact nature of this stunt is not revealed—the contestants only have the clue objects to go on. Chances are that they will interpret the clues wrongly and film something completely different. Or maybe they'll overcome the odds and get surprisingly close to the intended solution? We'll just have to wait and see.

When we see the contestants on the following week's programme, we see an edited version of the footage they have filmed. After each video, a panel of celebrity contributors comments on the contents. The host then reveals the ‘correct answer’ to the contestants. Once both films have been shown, the celebrity judges decide which team was closer to the correct answer and award them the prize.

For more information on how this format could be expanded to a full programme, please refer to section B.

Game 1a—Video Victors (as a Viewer-Only Game)

The same as the studio-based game, but with clues presented solely to the viewers and with the viewers creating the video clips themselves.

Game 2—Alternative Ending

Viewers are asked to speculate how a film or TV programme (which is specified beforehand) would have concluded if the ending was different, then video this and send us the results.

Game 3—Hard Sell

Viewers are asked to send in short adverts to sell a difficult concept they are given—e.g. tap water, fridges to the Eskimos.

Game 4—And . . . Action!

A video clip of (e,g.) a soap opera is shown and the action stopped at a crucial point. Viewers are invited to send in short video clips of how the clip should continue. Once the viewer's clip has been shown, the original clip continues to see if it makes sense!

Game 5—Quiz Charades

A general knowledge question is asked. The viewing audience has to send back a video of their answer. For example, if the question was “Which military parade takes place on the Queen's official birthday?”, the audience have to somehow enact Trooping the Colour in the most imaginative way possible.

FURTHER GAMES INCORPORATING A LIBRARY OF EXISTING AMUSING VIDEO CLIPS

Game 1—What happened next? aka ‘the alternative ending’, using the video library as the source.

Game 2—Video Voiceover

The audience is asked to video the show and playback a clip broadcast from the clip library and to ring a premium rate phone number and provide an amusing commentary/voiceover—these are collected and used in subsequent shows where the clips are reshown with the funniest of entries. They could also get the video from the web or eventually, video phones.

Game 3—Match the Person

These are games where several funny clips are shown and in the studio is one of the actual people involved or even just a compelling story about one of the people involved in one of the clips—quizzes/texting/phone-in/studio guests trying to match to the clip.

Game 4—Beat That Then

These are challenges where clips are shown and the audience is challenged to match/mimic/do the opposite of some aspect of it—could be a timed challenge with photo input or just another video challenge good old ‘look-alike’ challenges provide scope for fun and phone interview/teasing of people who respond.

Game 5—Beat That Then II

These are challenges where the audience are asked to go one further than what they saw in a clip—or challenged ‘well that could never happen in this country but what would be the equivalent?’

Game 6—Video Jig-Saw Puzzle.

2 teams in the studio. Each team has 6 giant bricks (cubes)—each cube has on one face a TV screen continually showing one 6th of a video clip over and over. The teams scramble to order the 6 TV cubes into the right order so that as soon as the winning team have done it, the chaos ends and the camera pans from cube to cube, (sound track on at this point) and the whole clip is seen in its hilarious totality.

Game 6—Video Jig-Saw Interactive

This works as described in game 6 above but with 2 celebrities in the studio frantically trying to put the cubes in the right order into numbered slots on a kind of giant shelf (or row of big colourful pigeon holes Labeled A through F ) . . . i.e. 2 celebs and 2 identical kits. The home audience can see most (enough) of the pictures to ‘have a go’

The celebs are guided by the home audience texting in the sequences (eg A4.B3.C2.D1.E6.F5)—big prize for their favorite celeb to help them in their task. The celebs see the statistics appearing on the video wall, suitably filtered and hard to interpret that the whole thing lasts around 2 mins. (the home audience gets a head start of say 2 mins so the texts can really pile in)
(an alternative could be instead of favorite celebs, split the country into 2, men vs women or whatever)
random prizes for home contestants—chance to phone in and play another game with them directing/competing.

### VIDEO VICTORS

### SECTION B—STAND-ALONE PROGRAMME FORMAT

Any of the strands in section A can be developed into a full programme. This section outlines how game #1 (Video Based Challenges) could form the basis of for example a full 30-minute programme. Premium rate text messaging of topical questions and answers to caption competitions are additional ways in which an even larger number of people can be involved.

### DETAILED OUTLINE

Our host enters a typical studio with audience, and introduces tonight's panel of three celebrity judges.

The game begins. The host reintroduces Team A from last week. Like all our teams, we gave them a handful of word and picture clues that related to a wacky, topical challenge to be filmed sometime during the week. The host welcomes team A back to studio and reminds everyone of the clues we gave them in the last show.

The host reads out some suggestions from the viewers as to what they thought the challenge was. We then see what the team actually filmed on video tape. The host banters with the judges for an initial reaction. The host slowly teases the teams with the correct answer—i.e. the challenge we intended given the clues available. Did they misinterpret the clues wildly (very likely!) or did they somehow get it right? Team A leave for now—we'll get the result later.

Host now introduces Team C, the first team for next week's show. The host gives them the clue objects and asks for their initial thoughts. The host turns to the camera and invites viewers to send in their ideas as to what they think the clues mean. They can do this via phone, email, SMS . . . or they could even video the challenge for themselves! The host weaves in this viewer feedback throughout the programme.

In Part 2, we repeat part 1 with teams B and D.

Our host builds to the final results. The judges deliberate which of the teams (A or B) provided the “best” video based on how close they got to the correct answer and entertainment value. Meanwhile, the host shows more clips from the audience input.

The judges announce winning team, who win electronic goodies as their prize. What will tonight's new teams (C and D) make of the clues we've given them? Tune in to the next episode of Video Victors to find out!

Viewer's Challenge

In addition, each programme contains a challenge for the home audience. The Viewer's Challenge follows the same pattern—a number of clues are shown on screen, which cryptically imply an event that will happen over the next few days. Viewers must use a video camera to record the task they think the clues are implying, then email their footage to the programme within a certain deadline. (Please refer to the technical presentation enclosed for further details on how the public can achieve this.) On the next week's show, the best (and worst!) efforts are shown on the TV programme and the judges award a second prize to the winning contributor.

Example Running Order

Video Victors is a free-form programme that contains a number of interwoven strands. Therefore, it is not possible to give an accurate running order as the length and order can be tailored to suit the slot available. However, as an example the show might proceed as follows:

| Titles | Run programme titles |
|---|---|
| Introductions | Host introduces themselves. |
| | Host greets celebrity judging |
| | panel. |
| Strand 1: | An audience member is pulled out |
| Instant | of the audience and given a |
| challenge | digital camcorder. They are |
| | challenged to film a certain |
| | scene or image (e.g. the “flying” |
| | scene from the film Titanic) and |
| | come back with it on tape before |
| | the end of the show. |
| Strand 2: | Host: “Last week, we introduced |
| Studio | you to contestants Daniel and |
| contestants | Steven. We gave them the |
| (team 1) | following clues: a tape measure, |
| | a large-scale map of the Scottish |
| | hills, an alarm clock and a very |
| | long rope. These all related to a |
| | topical event from last week.” |
| | We now see their VT diary, which |
| | shows the details of how they |
| | interpreted the clues, what they |
| | did to achieve their task and how |
| | they persuaded people to let them |
| | do it! |
| | Host chats with the panel of |
| | celebrity judges for their |
| | reaction. |
| | Host: “Now let's see what the |
| | clues should have actually led |
| | you to . . . ” Host gradually |
| | explains the intended solution |
| | for all the clues, almost to the |
| | point of teasing the contestants: |
| | “A Scottish hill is called a ben, |
| | and these are large-scale hills |
| | on this map so they are big bens. |
| | The tape implies measuring |
| | something, and the alarm clock |
| | implies something to do with |
| | time. Well, these clues - |
| | combined with the fact that last |
| | week was World Abseiling Week - |
| | should have led you to the answer |
| | that we wanted you to measure the |
| | height of the famous Big Ben |
| | clock tower by abseiling down |
| | it!” |
| | We get to see the contestants' |
| | reaction - either one of despair |
| | (“Why didn't we think of that?”) |
| | or possibly delight (“That's the |
| | task we actually filmed!”). |
| | Host chats with celebrity judging |
| | panel for their reaction. |
| | Side note: A dangerous task like |
| | this would be set-up in advance |
| | and the contestants would be |
| | monitored at all times. Of |
| | course, the contestants might not |
| | work out the right answer and may |
| | well do a completely different |
| | task instead. |
| Strand 3: | Host: “Here are new contestants |
| Studio | Michel and Jean-Claude. Here are |
| contestants | your clues . . . ” |
| (team 1 | Host asks for immediate reaction |
| for next week) | from contestants as to what they |
| | think the task might be. |
| | Contestants leave studio, we'll |
| | see them on the next show in a |
| | week's time. |
| Strand 4: | Last week, the clues for the |
| Viewer's | Viewer's Challenge were a tea |
| Challenge | cup, a globe, a can of dog food |
| | and a whistle. Noting that the |
| | football World Cup final took |
| | place this week, this should have |
| | led you to this solution - we |
| | wanted you to organise then film |
| | a football World Cup competition |
| | for dogs! |
| | Here are some of the more bizarre |
| | entries we received . . . (play clips) |
| | But some people managed to guess |
| | the solution correctly. Here are |
| | the five best clips . . . (play |
| | clips). Which one will win? Find |
| | out in 3 minutes . . . (hook into |
| | the break) |
| | COMMERCIALS (if required) |
| Strand 4 | Celebrity judging panel decide on |
| conclusion: | which of the five clips sent is |
| | the best. |
| | Winner looks pleased and gets |
| | prize. |
| | Now here are the clues for this |
| | week's challenge. They are . . . a |
| | golf club, a rocking horse, a |
| | video of Marilyn Monroe and the |
| | sound of a glass smashing. What |
| | can they all mean? They all |
| | relate to an event that will |
| | happen in the next 48 hours. If |
| | you think you can complete and |
| | film the task, send us your video |
| | clips via our web site and you |
| | could win a great prize! We'll |
| | reveal the answer and show the |
| | best clips next week. |
| Strand 2: | Last week, we introduced you to |
| Studio | contestants Dan and Steve . . . |
| contestants | (proceeds exactly as for team 1). |
| (team 2) | |
| Strand 3: | Host: “Here are new contestants |
| Studio | Jean and Klauss. Here are your |
| contestants | clues . . . “ (proceeds exactly as |
| (team 2 | for team 1). |
| for next week) | |
| Strand 1 | The audience member we sent out |
| conclusion: | at the beginning of the show now |
| Instant | returns back to the studio. We |
| challenge | see a short clip of the instant |
| | challenge that has been filmed |
| | and edited together while the |
| | rest of the show was being |
| | recorded. |
| | Host asks the celebrity judges to |
| | comment and agree on whether they |
| | think the challenge was |
| | successful. If they agree, the |
| | audience member gets to keep the |
| | digital camcorder. |
| Strand 2 | Finale: Host recaps on the two |
| conclusion: | films shown tonight. |
| Studio | The winning team is decided by a |
| contestants | judges' decision or an audience |
| | vote, as desired. They are the |
| | Video Victors for this week! |
| | The winning team wins a |
| | technological-based prize (see |
| | next section). |
| Sign off | Host reminds viewers of the clues |
| | for this week's home challenge. |
| | Host reminds viewers that they |
| | can see this information and |
| | watch more clips from this week's |
| | viewer's challenge on our website |
| | at www.videovictors.com |
| | See how our new contestants fare |
| | on next week's show. Goodbye! |

Prizes

The prizes offered to winning contestants (either the studio contestants or the winner of the viewer's challenge) can be technological—e.g. PCs, digital cameras, videophones etc.

Alternatively, they could be related to the stunt that they have achieved (or failed to achieve!) in the main programme. For example, the winner of a challenge involving switching on the lights on a skyscraper so that they spell out a message might win a trip to Kuala Lumpur in Malaysia to see the record-breaking Petronas Towers skyscrapers.

Practical timetable—Studio Contestants

For the purpose of demonstration, this timetable assumes the programme goes out on Friday evening.

| | |
|---|---|
| Thursday pm | Programme 1 recorded. Two sets of |
| | contestants are given clues to their |
| | task. |
| Friday am | Contestants record their task at |
| onwards | some point during the next three |
| | days. Technical crew and a safety |
| | supervisor accompany them. |
| Monday pm | Deadline for finishing filming |
| | tasks. |
| Tuesday am | 21/2 days allowed for editing together |
| | the recorded events into the video |
| | diary packages. This is mainly done |
| | by the director, with some input |
| | from the contestants if |
| | circumstances allow. |
| Thursday pm | Programme 2 recorded, including |
| | showing the video diaries. Two new |
| | sets of contestants are given clues |
| | to their task for the coming week. |
| Friday pm | Programme 2 broadcast etc. |

Practical Timetable—Audience Challenge

Again, this timetable assumes the programme goes out on Friday evening.

| | |
|---|---|
| Friday pm | Programme 1 broadcast. Contains |
| | clues for the Viewer's Challenge |
| | that relates to an activity over the |
| | coming weekend. |
| | Web site updated with additional |
| | clips from this week's show. |
| | Additional hints to the challenge |
| | also given out on the web site. |
| Saturday/Sunday | Audience film their masterpieces. |
| Monday pm | Deadline for audience participants |
| | to have emailed the show with an |
| | ‘MPEG’ clip of up to 60 seconds of |
| | footage from their exploits. |
| Wednesday am | Since the weekend, the production |
| | team will have been reviewing the |
| | entries sent in by the public. This |
| | is the deadline for the final |
| | selection of which clips will be |
| | short listed for the viewer's prize |
| | on the next show. |
| Wednesday pm | Time window available to fetch |
| | original videotape (or receive more |
| | footage via a cable modem, if |
| | available) from the contributor and |
| | re-cut professionally in an edit |
| | suite if thought necessary. |
| Thursday am | Edit together audience challenge |
| | clips for tonight's recording. |
| Thursday pm | Next TV programme recorded as-live. |
| Thursday | Opportunity for minor editing to |
| late to | polish up rushes. |
| Friday am | |
| Friday pm | Programme 2 broadcast etc. |

Studio Requirements

Other than the need for some kind of video screens/video wall to display the photos and clips, there are no particular requirements in terms of the studio's design.

It is envisaged that a video wall would effectively present the multiple images required to engage the viewer into the belief that, with many images appearing and disappearing, that there was as a real chance of their photo appearing in the show. Alternatively the pictures or videos can be inserted electronically into predetermined areas of the studio camera's view by use of colour key techniques.

Management of JPEG (photo) images and MPEG (video) clips streaming in from the public is part of the invention. An sms text message transaction between the broadcaster and the viewer ensures a clear billing point and registration of entries from the public, independent of the exact equipment being used by them.

For broadcast of an incoming picture: the viewers' pictures are in JPEG format whereby the resolution provided by the participant's mobile camera device is ‘mapped’ to the resolution of the studio's video equipment. For example, a 640×480 pixel picture can map to full screen of a typical PAL 625-line transmission system to give an acceptable quality of reproduction when viewed by the public on a traditional 4:3 aspect ratio television screen. Lower resolution pictures are ‘mapped’ to a correspondingly smaller display where the production team show either a ‘picture frame’ or other images around the resulting transmitted picture. In the case where multiple viewers' entries are shown on a ‘video wall’, the same principle applies although dedicated DSP-based scaling devices can also be employed to make all pictures appear the same size.

An improvement with this invention is that apart from a crude selection process, the viewer is actually creating the pictorial content for the broadcaster with none of the intermediate artistic steps traditionally associated with the reprocessing of traditional media. This enables a broadcaster to have the possibility of making use of content from any of many hundreds of thousands of entries received from the public in a very short space of time.

In the context of the present invention, the production team can quickly review multiple jpegs and mpegs from thumbnail menus to allow quick review and selection of viewers' inputs from the assemblage of material that the invention provides.

The possibility for live camera feeds from particular viewers is afforded by this invention. For example, home participants can actually appear in the studio audience by having their face displayed on display monitors that are mounted around the studio.

Role of Supporting Web Site

The main support features offered by the supporting web site will include:
Being the ‘portal’ for all internet-submitted content (viewers will need to enter an access code which they get as a premium-rate text message on their mobile phone)
Background on the programme (behind the scenes information, host interviews etc.).
Details of broadcast times.
Step-by-step guide to filming clips, including safety notices and disclaimers.
Reminders of the clues for this week's Viewers' Challenge (this may include a few additional hints not broadcast on the main TV show).
Email address for sending clips into the programme.
Downloadable extended/additional clips from all this week's challenges which did not quite make it onto the TV programme itself.

The site also provides other related areas to do with multimedia comedy, such as:
Daily run-down of satirical/topical jokes, including prizes for gags or stories suggested by web visitors.
Database of joke/spoof pictures and video clips you can send to friends.

Humorous articles (e.g. ‘101 wacky things to do with fax machines’).

End of appendix I

### Appendix II

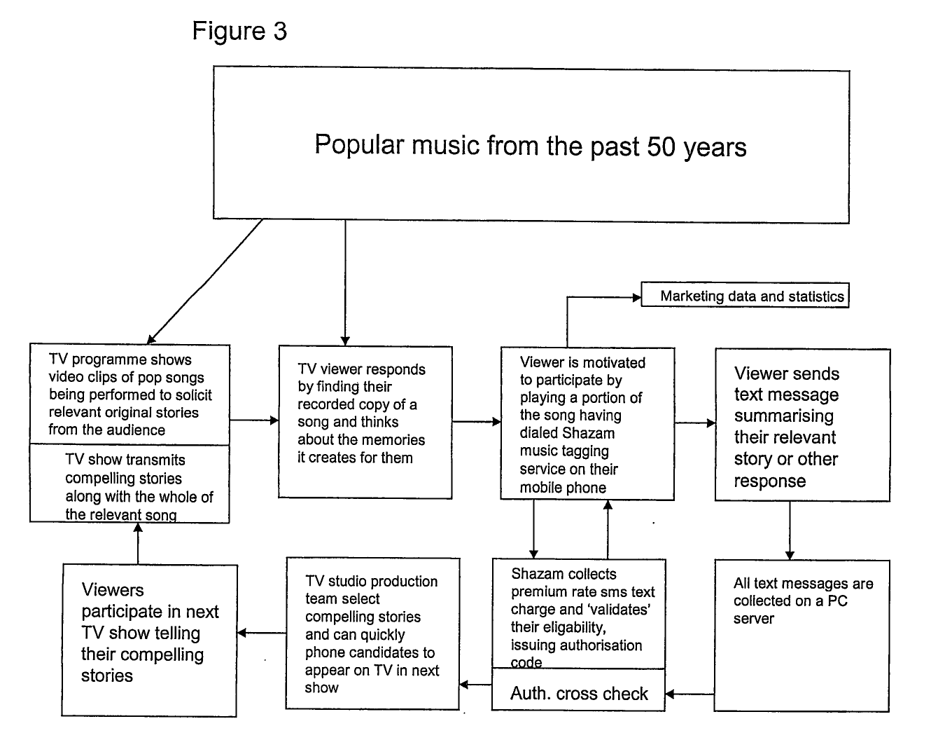

### FIG. 3 Shows the Flow in Pictorial Form

### POP PASSIONS—INTRODUCTION

‘Pop Passions’

A 13×50 min format

Pop Passions (Match the Music) is a blend of archive ‘Top of The Pops’ and ‘This Is Your Life’.

The concept:

An interactive format that inspires viewers to search their personal music library and to share compelling personal stories that lie behind certain discs.

The core aim is for the viewer to be able to match a chosen disc with one from their own collection and then to let two stories unfold.

One story is told through archive footage about the song, and the second story is told by the viewer through the viewer's personal associations with that particular piece of music.

Key Elements of the Format:

Access to a music archive, with short clips shown for the audience to choose from, and have the potential to become studio participants in the next show.

Access to the Shazam interactive phone technology. (A dedicated phone number that verifies a particular piece of music from the viewer's music collection)

### POP PASSIONS—PROGRAM STRUCTURE

The host-led show consists of 3 segments which are identical in their format apart from topping and tailing the show with introductions at the start, and a recap at the end enticing wannabees to participate.

Each segment includes a 2 minute medley of 8 clips from pop performances in the archive . . . these are the ‘teasers’ from which people at home see if they can ‘match the music’ AND have a powerful story relating to it.

Each segment consists of 2 ‘story pairs’. The ‘story pair’ is footage of the pop record and then the personal story of the studio participant.

### POP PASSIONS—PROGRAM MINI-SCRIPT EXAMPLE

Titles

welcome to pop passions
in part 1 of the show we meet the guy with an incredibly scary personal story relating to his copy of Heartbreak-hotel and the most amazing couple from Bolton who ended up seperated for 5 years all due to their copy of ‘return to sender’ . . . then we see a reminder of the clip (then other interesting footage from the archives about the song) then the personal story from the guy (who's been invited into the studio following a phone interview by the researcher from the short list of people who matched the song clip shown the prior week, and sent an attractive looking sms) same for the second song and the couple from Bolton. end with 8 clips for next week . . . to get people thinking if they have this song/a good story.

Part 2 and part 3 are just the same. ie 2 more songs/guests+stories, then a few words about the rules for getting on the show, with a final exhortation/run though/reminder 5 seconds per clip of the 24 choices from which people can see if they have the record/cd and have an amazing story to go with it.

Do you have a copy of any of the songs we played? If so, you have 48 hours from now, to dig it out/dust it off. Play it on your cd or record player/wind-up gramophone or reel-to-reel tape recorder, nice and loud, then all you have to do is dial 2589 on your mobile and let the call last for 30 seconds—if you have it or one of our chosen versions of the song then you will receive back an sms telling you what to do next to send in your text describing your amazing personal story.
(what they get is a code which they must include at the start of texting their story—this ties together text and the fact they have the record.

(Shazam technology is described on http://www.shazam.com/uk/do/about and can be set up to work in any territory of the world with no new infrastructure (just a simple telecom arrangement))

Studio Requirements

No special requirements.

The researchers for the show will need access to the library of sms text messages and phone numbers collected by Shazam. These can be sent to the studio electronically. The researchers will then interview the senders of the best-looking submissions to assess the value of their story. The short list of participants are then invited to the studio for the shooting of the next show. Each show would have an eclectic blend of the sad, the happy, the scary, the intriguing and so on. This, spread across a wide age range of participants makes the show ideal for a prime-time slot.

Other Notes

The songs can be as recent as just a year or two old to make sure we attract a full age-range of viewers! (literally ages 12-100!)

The 15 second samples shown as teasers will always be just too short for Shazam to ‘approve’ it—to stop people just playing back the song from their video player!!!!

Great opportunity for tabloid press to build participants into min-celebs.

Statistics based on Shazam responses as to who has what old records/ which ones get more responses.

A chance for the music folks to offer specific cd's and dvd's to the responding and very targetted audience. (via text back and eventually video clips)

1-37. (canceled)

38. A television format involving the steps of
a) distributing clues defining a situation to be broadcast as a television segment;
b) receiving a plurality of presentations showing segments in picture or video form, each received segment being based on an interpretation of said clues:
c) selecting at least one of said presentations for broadcast.

39. The format of claim 38 including the step of providing a channel for receiving a home based presentation.

40. The format of claim 38 wherein selection of a received segment for broadcast is based on a best fit with the situation defined by the clues.

41. The format of claim 38 wherein selection of a received segment for broadcast is based on a least best fit with the situation defined by the clues.

42. The format of claim 38 wherein a selection of a received segment for broadcast is based on a perverse or contrary fit with the situation defined by the clues.

43. The format of claim 38 wherein said selection is competitive.

44. A method of doing business including the steps of generating revenue from contestant submission of program material to be broadcast.

45. A method of configuring picture or video data to be broadcast including the steps of collection said data at a remote site, transmitting said data in a compressed format in accordance with a first standard to a program creation suite, using said data to create a program segment, and broadcasting said data in accordance with a second standard.

46. A method of assembling program material involving the steps of:
d) distributing clues defining or alluding to content to be broadcast as a television segment or assembled for that potential purpose;
e) receiving a plurality of content presentations, received content being based on an interpretation of said clues; and
f) forming said received content into an assemblage of material for broadcast.

47. A method of receiving program content as claimed in claim 46 including the step of collecting data regarding content submitters including personal; equipment or content type.
